(19) United States
(12) Patent Application Publication
(10) Pub. No.: US 2004/0190906 A1
(43) Pub. Date: Sep. 30, 2004

(54) Method and apparatus for simultaneous optical compensation of chromatic and polarization mode dispersion

(76) Inventor: Ajay R. Jain, Palo Alto, CA (US)

Correspondence Address: Ajay R. Jain, 200 Western Ave., Brattleboro, VT, 05301-6221, US

(21) Appl. No.: 10/810,460

(22) Filed: Mar. 26, 2004

Related U.S. Application Data
(60) Provisional application No. 60/457,327, filed on Mar. 26, 2003.

(51) Int. Cl. H04B 10/12

(52) U.S. Cl. 398/147

(57) ABSTRACT

Chromatic and polarization mode dispersion can be optically compensated with an All Optical Dispersion Compensator (AODC) of the present invention. The AODC compensates group delay in each polarization axis of an incoming dispersed signal pulse using multi-cavity Gires-Tournois resonators (MCGTR) and a feedback mechanism. Chromatic and polarization mode dispersion are compensated concurrently or independently.

### BACKGROUND

This application is entitled to the benefit of Provisional Patent Application Serial No. 60/457,327 filed Mar. 26, 2003, the disclosures of which are incorporated herein by reference.

### FIELD OF THE INVENTION

The present invention relates to an optical device for simultaneously or independently compensating for chromatic dispersion and polarization mode dispersion in high-speed optical communications networks.

### BACKGROUND OF THE INVENTION

The advent of optical networks that employ dense wavelength division multiplexing to transmit as many as 160 individual streams of data over a single optical fiber have opened a new era in communications. To be competitive in the new technology environment, telecommunications service providers must now drive down the cost per transmitted bit by selecting from a new generation of cost effective technologies that promise to dramatically reduce operating and capital costs. Not only must new optical networks handle faster transmission speeds and increased channels counts, but they must also achieve higher throughput with less maintenance and investment.

The increase in bandwidth, however, is limited by a number of fundamental factors such as attenuation, noise and dispersion. In particular, dispersion is problematic because it distorts and or broadens the optical pulses used to carry information over the optical fibers thereby leading to data transmission errors especially in high speed, long haul systems.

There are two types of dispersion impairments that are typically present in a communication system: chromatic and polarization mode dispersion.

The input stream of an optical transmission system may be viewed as a series of light pulses representing digital bits. The bit rate of newer optical transmission systems generally ranges from 10 Gbps to 40 Gbps resulting in light pulses (or bit periods) that are 100 to 25 picoseconds in length depending on the modulation format. Receivers in an optical transmission system convert each bit period in the data stream into digital ones or zeroes by determining whether a light pulse has been received (one) or not (zero).

The light pulse in such a system can distort such that different spectral components of the pulse arrive at different times at the receiver, a phenomenon known as chromatic dispersion (CD). Furthermore, the light pulse in such a system may additionally be distorted by the different orthogonal polarization states arriving at different times at the receiver. This is known as polarization mode dispersion (PMD).

Either of these phenomena may distort the light pulse of the data stream and thus impair the ability of the receiver to determine whether a bit period should be converted into a one or zero. As a result, these impairments limit the transmission accuracy and capacity of optical transmission systems.

PMD and CD look similar to the receiver. They each cause an increase in the bit error rate (BER). CD occurs fairly predictable as a function of the length of fiber and line rate. CD increases at the square of the increase in data rate. A signal traveling at 40 Gbps, for example, is sixteen times more sensitive to CD than one at 10 Gbps. 10 Gbps line rates generally require static CD compensators, while at 40 Gbps tunability is required to manage the lower threshold of CD the receiver can tolerate.

In most single mode fiber, chromatic dispersion also varies for any given number of wavelengths within the commonly used C-Band transmission window. This second order phenomena is known as fiber slope. The fiber slope may also require flattening, particularly when ITU frequencies at the edges of the C-Band are used.

PMD is much less predictable than CD. It results from fiber asymmetry, vibration or temperature changes that affect the two orthogonal polarization planes causing one axis to propagate at a greater velocity than the other. At 40 Gbps, PMD is four times worse that at 10 Gbps, and is serious enough to severely limit the maximum fiber distance before the signal must be regenerated. PMD occurs randomly and cannot be predicted for any given fiber span at any given time. There is also a frequency dependent higher order PMD effect.

Numerous inventions have targeted the need for either CD or PMD compensation, but few possess the dual capability to address both simultaneously, or the flexibility to address one or the other independently. The present invention can be configured as a tunable CD compensator, a tunable PMD compensator, a tunable CD and PMD compensator, or as a fixed CD compensator with the result that manufacturing economies of scale may be brought to bear to reduce unit costs.

One approach to dispersion compensation is to utilize electronic dispersion compensation (EDC) circuitry at the receiver to repair the optically dispersed signal in the electrical domain using digital signal processing (DSP) techniques to improve the BER. While effective to an extent, EDC solutions are, by definition, end of line, single frequency solutions. In contrast, the present invention can be utilized as a multi-channel device to: actively mitigate PMD in the channel with the poorest performance among a set of channels; actively compensate for CD and or PMD in a single channel; or compensate for CD in multiple channels actively, passively or reconfigurably. Optical dispersion compensation can be deployed at multiple network locations in addition to the receiver: at a transmitter, an amplifier, or an add-drop multiplexer, and has the advantage of compensating for a greater magnitude of dispersion compared with EDC solutions. Deployment flexibility provides optical network designers the added capability of managing dispersion levels for optimal signal integrity over the longest possible reach.

### SUMMARY OF THE INVENTION

In accordance with the present invention, an optical device comprising a polarization controller, two polarization beamsplitters, four waveplates, four resonators, an input, and an output compensates for chromatic dispersion and polarization mode dispersion in optical networks simultaneously or independently.

The invention functions by separately compensating for group delay in each axis of polarization of the input light in one arm using a pair of resonators, while also compensating for group delay in a second downstream arm using a pair of resonators that exhibit the inverse group delay function of the first pair. By tuning the filters separately, or in tandem, CD and PMD can be tuned simultaneously or independently.

Although multi-stage or multi-cavity resonators of the class of optical resonator known as multi-cavity Gire-Tournois etalons are preferable for compensating for group delay, the invention can also function using single cavity resonators. Moreover, any optical filter that can compensate for group delay can be used in the apparatus of the preferred embodiment such as balanced Fabry-Perot filters, spatially variable coating etalons, or non-linearly chirped fiber Bragg gratings.

Several different embodiments of the present invention are described and claimed.

In one alternate embodiment, the number of elements is reduced by elimination of waveplates through a reconfiguration of the optical scheme.

In another embodiment, CD and PMD are compensated for in series, as opposed to parallel as in the preferred embodiment.

Another specific embodiment that employs finite impulse resonator (FIR) filters and ring resonators is also shown and claimed.

### OBJECTS AND ADVANTAGES

The following are objects and advantages of the present all optical dispersion compensator (AODC) invention:

Differential group delay (DGD) and CD impairments can be compensated in a single micro-optical module resulting in a reduction in the total number of components in a given optical network.

The AODC module can provide a fixed magnitude of compensation, or can be tuned to compensate for DGD, or CD, or DGD and CD simultaneously.

Through appropriate selection of free spectral range (FSR) of all-pass resonator filters, dispersion can be tailored for any line rate, fiber type, bandwidth, and channel spacing.

Use of an all-pass filter arrangement at zero degree angle of incidence (AOI) in the AODC results in minimal insertion loss.

In the preferred embodiment, input and output light paths are spatially separated avoiding the additional cost, volume, and insertion loss of a circulator.

Separate input and output paths also minimize refractive and coupling losses.

Optical path design allows for monolithic construction, which, in turn, allows for pre-alignment of output interface and no beam walk off.

Higher order chromatic or polarization mode dispersion can be compensated.

The apparatus can be configured to provide both positive and negative dispersion compensation.

The apparatus can be configured for minimal dispersion ripple.

The apparatus does not exhibit non-linear effects from changes in the magnitude of laser energy.

Due to its periodic design, a single AODC module functions equally across any ITU channel in the C, L or S bands.

Tuning can be stepwise or continuous, and latchable to reduce power usage.

Tuning speed can be tailored to requirements.

The AODC can be configured to compensate for the dispersion caused by other optical network filter components such as arrayed waveguides (AWG), fiber Bragg gratings (FBG), thin film filters (TFF), amplifiers, and optical switches.

Because of its low cost, low insertion loss and compact design, the AODC is cascadable to provide added magnitude of compensation, or higher order compensation.

Further objects and advantages of the present AODC invention will become apparent from a consideration of the drawings and ensuing description.

### BRIEF DESCRIPTION OF THE FIGURES

FIG. 1 is a schematic of a prior art PMD nulling device.

FIG. 2 is a schematic of the instant CD/PMD nulling apparatus.

FIG. 3 is an overlay plot of amplitude and group delay for an all-pass single cavity etalon.

FIG. 4 is an overlay plot of amplitude and group delay for an all-pass, four coupled cavity etalon. The straight line depicts desired group delay in the pass band region.

FIG. 5 is a schematic of the preferred embodiment of the invention.

FIG. 6a-d depict the group delay of each resonator of the preferred embodiment at t=0.

FIG. 7a depicts the group delay of each resonator pair at t=0.

FIG. 7b depicts the net group delay of the two resonator pairs at t=0.

FIG. 8a-d depicts the group delay of each axis of polarization experienced by each resonator in the preferred embodiment at t=0.

FIG. 9a depicts the group delay of each resonator and the DGD of each resonator pair at t=t.

FIG. 9b depicts the net group delay and net DGD of both resonator pairs at t=t.

FIG. 10 depicts an alternate embodiment of the AODC with the resonators configured at non-normal incidence.

FIG. 11 depicts another preferred embodiment of the AODC employing a multi-port circulator.

FIG. 12 depicts an alternate embodiment wherein the two polarization beamsplitters are replaced by two beam displacers.

FIG. 13 depicts an alternate embodiment with a polarization controller in an alternate location, and a multi-port circulator.

FIG. 14 depicts yet another alternate embodiment utilizing ring resonators.

FIG. 15 depicts an alternate embodiment using FIR filters.

FIG. 16 depicts a first alternate embodiment using linearly chirped fiber Bragg gratings.

FIG. 17 depicts a second alternate embodiment using linearly chirped fiber Bragg gratings.

FIG. 18 depicts an alternate embodiment using non-linearly chirped fiber Bragg gratings.

FIG. 19 depicts an unbalanced Fabry-Perot filter of a type that can be used in an AODC.

FIG. 20 depicts a spatially variable coating etalon of a type that can be used in an AODC.

### DETAILED DESCRIPTION OF THE INVENTION

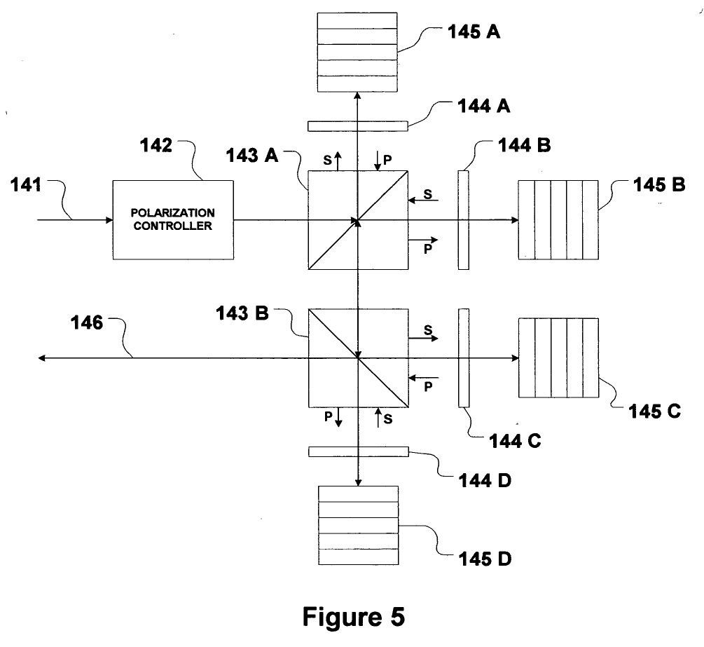

FIG. 5 is a preferred embodiment. In this schematic, two polarization beam splitters (143a and 143b) are optically coupled in the north, south axis. The northern polarization beam splitter (PBS1) (143a) is also optically coupled on its north face to a waveplate retarder (WR1) (144a), which is, in turn, optically coupled to a multi-stage GT resonator (R1) (145a). The eastern face of PBS1 is also optically coupled to a second waveplate retarder (WR2) (144b) and this waveplate, in turn, is optically coupled to a second multi-stage GTI resonator (R2) (145b).

Similarly, the eastern face of the southern polarization beamsplitter, (PBS2) (143b) is optically coupled to a third waveplate retarder (WR3) (144c) which, in turn, is coupled to a multi-stage GT resonator (R3) (145c); and the southern face of PBS2 is optically coupled to a fourth waveplate retarder (WR4) (144d) which is, in turn, optically coupled to a fourth multi-stage GT resonator (R4) (145d).

The western face of PBS1 is furthermore optically coupled to a polarization controller, (PC) (142), which is, in turn, optically coupled to a light input from a waveguide (141).

The western face of PBS2 is optically coupled to a fiber output (146) or alternatively, directly to a receiver (not shown).

Reference to north, south, east, and west are for purposes of descriptive clarity. Other orientations are also possible. Reference to orientation is not meant to limit the claims.

### Operation of the Invention

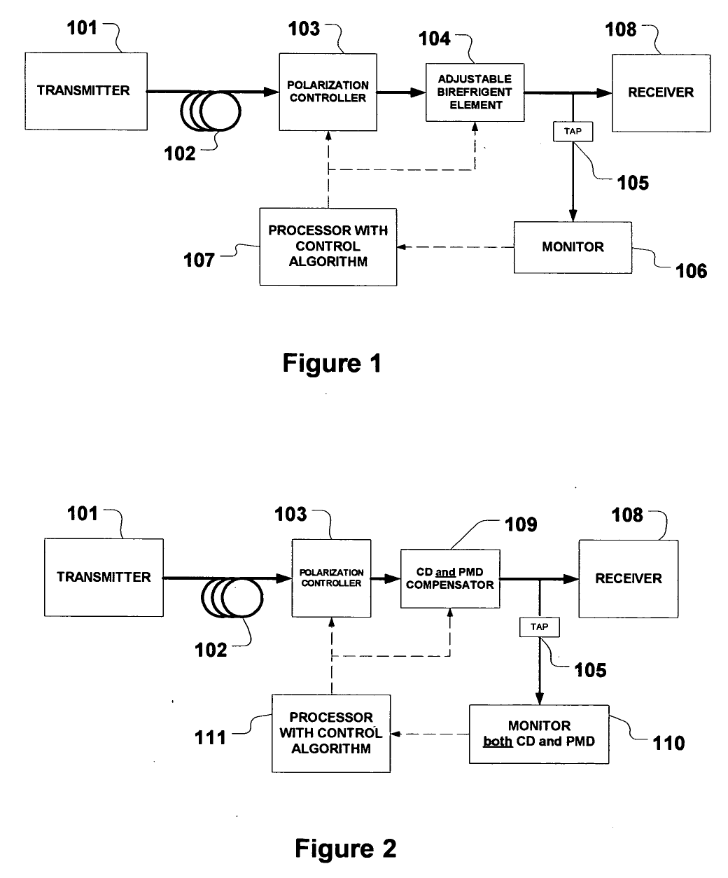

FIG. 1 depicts how PMD nulling has been attempted in prior art. The circuit diagram consists of a transmitter (101), an optical fiber (102), and a receiver (108). A PMD compensator is, in turn, composed of a polarization controller (PC) (103), an adjustable birefringent element (104) to dynamically vary DGD, and a tap (105) that feeds a signal to a monitor (106). This signal subsequently feeds into a decision-making unit that includes a control algorithm (107) that provides a closed feedback loop to the PC (103) and an adjustable birefringent element (104) to regulate PMD.

FIG. 2 is a schematic of the instant invention. Note that FIG. 2 varies from FIG. 1 in as much as the birefringent element (104) in FIG. 1 is now replaced by an all-optical dispersion compensator (AODC) (109). Both CD and PMD are monitored (110), and this monitor is connected to a processor with supplementary control algorithms and features for controlling both CD and PMD in the AODC (111). The device in FIG. 2, however, has the added capability of dynamically compensating for CD as well as PMD.

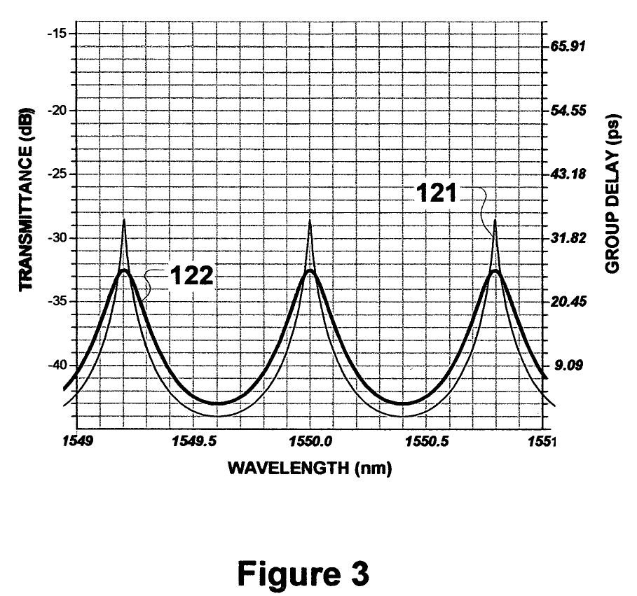

FIG. 3 is a theoretical plot of a single cavity ‘all-pass’ etalon filter design with a free spectral range (FSR) of 100 GHz (0.8 nm). Amplitude (122) and GD (121) are plotted and overlaid. An ‘all-pass’ filter, also referred to as ‘Gires-Tournois’ (GT), has one surface with a reflectivity value approximating 100%, and a second surface with a reflectivity value of less than 100%. An all-pass filter corrects for phase without affecting amplitude. An etalon is also referred to as a ‘resonator’, and the phenomenon wherein light satisfying some boundary condition re-circulates within the resonator cavity is termed ‘resonance trapping’. The wavelengths that satisfy the on resonance criteria (m lambda/2) are maximally delayed in the resonator. Similarly, the wavelengths that satisfy the off resonance criteria (m lambda/4) are minimally delayed. In FIG. 3, the group delay (GD) at the on resonance wavelength of 1550 nm is 35.1 ps and the GD at the off resonance wavelength of 1550.4 nm is only 3.0 ps.

Wavelengths between the maximally and minimally delayed wavelengths suffer GD as well, following a Gaussian profile. This profile is dependent on the reflectivity values of the resonator surfaces.

If this resonator could be tuned such that the maximal GD shifts from 1550 nm to 1550.4 nm, any signal at 1550.4 nm passing through it would consequently experience a GD of 35.1 ps and any signal at 1550 nm would experience a GD of 3.0 ps.

One millimeter of glass has a GD of 3.3 ps, therefore 10 mm of glass material would be necessary to achieve a GD of ˜33 ps, whereas a 1 mm glass etalon could accomplish the same magnitude of group delay due to its inherent resonance trapping ability.

A typical NRZ modulated light pulse transmitted at a speed of 10 Gbps, as is common in optical communications, requires a spectral bandwidth of approximately 10 GHz (0.08 nm). Likewise, an NRZ pulse at 40 Gbps requires a bandwidth of 40 GHz (0.32 nm). For RZ modulation, the spectral bandwidths are 20 GHz and 80 GHz, respectively.

As is clear from FIG. 3, a single cavity resonator does not provide ample bandwidth to compensate for chromatic dispersion in high-speed fiber optic networks. Cascaded or optically coupled multi-cavity resonators, however, can be constructed that will both increase the linear GD region across the spectral bandwidth and the total magnitude of GD. Saw tooth type and rectangular shaped pass bands can be readily created using multi-cavity Gires-Tournois resonator designs.

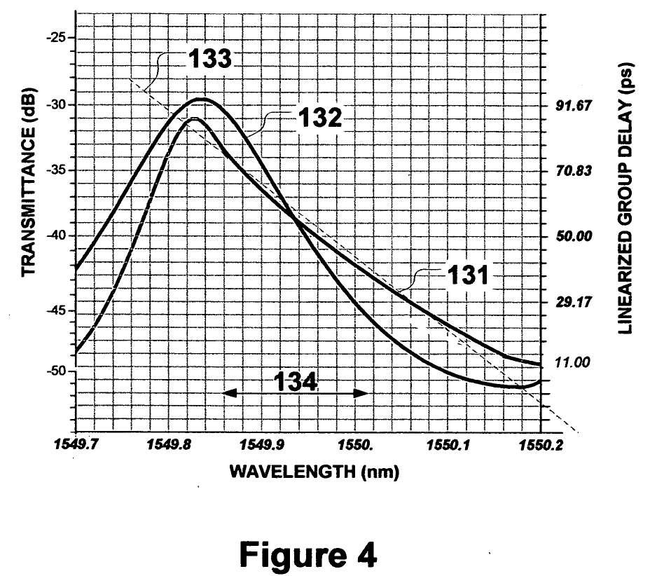

FIG. 4 is a theoretical plot of an exemplary four cavity resonator of a saw tooth design that displays a maximal GD of 86 ps and a minima of 11 ps. Note the linearized negative slope of the GD (131) that extends 0.16 nm (20 GHz) (134) across the pass band to provide ample bandwidth for a RZ modulated signal at 10 Gbps. The ideal linearized negative slope of GD (133) is depicted as well as transmittance (132).

Now refer to FIG. 5, which illustrates the function of an all-optical dispersion compensator (AODC).

Input light from a waveguide strikes a polarization controller (PC) (142), which aligns the fast and slow axes of the light pulse with the p and s axes of the adjacent polarization beamsplitter. The light exiting the PC then strikes a polarization beamsplitter (PBS1) that allows the p axis to pass and reflects the s axis. The reflected s axis, in turn, passes through a waveplate retarder (WR1) (144a), which converts the linearly polarized light into circularly polarized light. The s axis light continues on, passing into and then reflecting back out of the multi-stage GT resonator (R1) (145a) that serves to phase correct the light without affecting amplitude. As the reflected light pulse passes back through WR1 (144a) it changes back into linearly polarized light of opposite polarity (s is now p). Again, p is passed by PBS1 (143a); and continues on to PBS2 (143b) where p is also passed through; strikes WR4 (144d) where it is converted from linearly polarized light to circularly polarized light; passes into R4 (145d) and is reflected back out; again strikes WR4 (144d) where it is converted into linearly polarized light of opposite polarity (p is now s again); is reflected by PBS2 (143b) into an output fiber waveguide (146) or directly into a receiver (not shown). To review, the original s axis of light that exited the PC follows a path that takes it through both R1 and R4 in its s axis state. R1 and R4 act to process the phase, and therefore the GD, of the s axis light without affecting amplitude.

In a similar fashion, the p axis that exits the PC; passes through PBS1 (143a); on through WR2 (144b); into and back out of R2 (145b); once again through WR2; where it converts to s; reflects off PBS1; travels on to PBS2 (143b); through WR3 (144c); into and back out of R3 (145c); passes back through WR3 where it finally converts back to p; propagates back through PBS2 (143b); and on to output (146). To summarize, the original p axis encounters both R2 and R3, which act to process phase, but not amplitude.

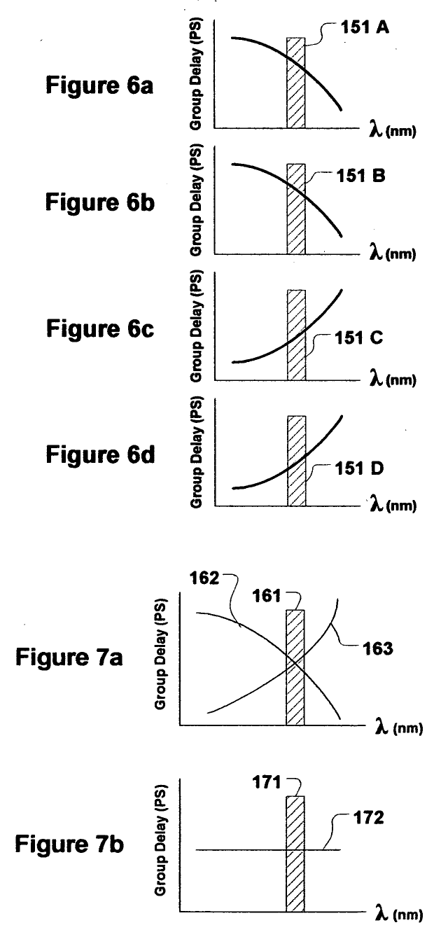

In this example at t−0, if resonator R1 and R2 give an identical GD response to one another, and R3 and R4 are also identical to one another, but R3 and R4 give an inverse response to R1 and R2, then the GD and DGD of the light exiting the AODC is unchanged from the input light as is shown in FIGS. 6 and 7.

In another example at time-t, assume that the input light suffers only from CD impairment. Refer again to FIG. 5. Now tune the GD vs. wavelength (WL) function of R1 and R2 relative to that of R3 and R4. Provided the GD vs. WL function of R1 remains constant relative to the GD vs. WL response of R2; and the GD vs. WL function of R3 remains constant relative to that of R4, the GD of the input signal can be modified to compensate for CD with no consequent effect on the DGD of the output signal.

In another example at time=t, assume that the input light suffers only from PMD impairment. Refer again to FIG. 5. Now tune the GD vs. WL function of R1 versus R2 and tune the GD vs. WL function of R3 vs. R4 by an identical amount. In this example, the DGD of the input light will change without affecting the CD of the input light.

In the final example at time=t, assume that the input light suffers from both CD and PMD impairment. Refer to FIG. 5. In this example, the GD vs. WL function of R1 is tuned relative to the GD vs. WL function of R2, and the GD vs. WL function of R3 is tuned versus that of R4 to achieve the desired DGD between the axes of polarization. Simultaneously, the GD vs. WL function of R1 is tuned vs. R4 and the GD vs. WL function of R2 can be tuned vs. R3 to achieve CD compensation. With these four degrees of freedom, both the CD and PMD (DGD) of the input signal can be compensated.

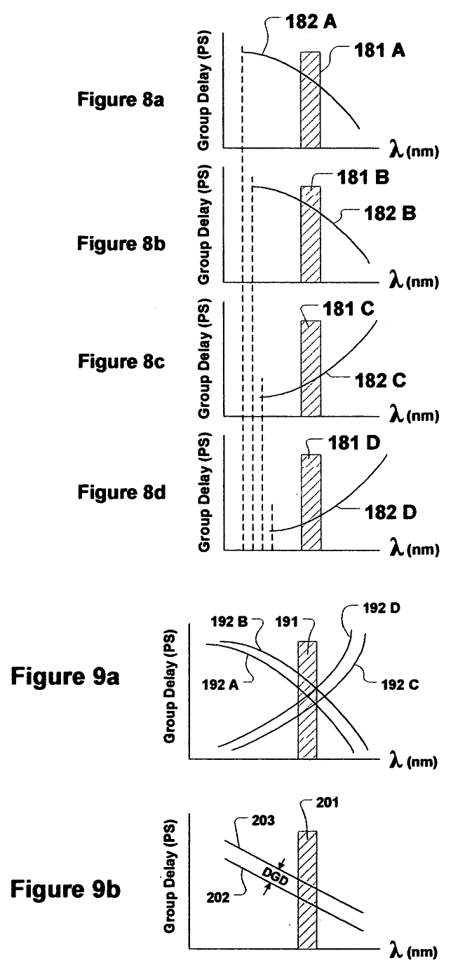

Tuning of CD and PMD is graphically depicted in FIGS. 8a-d and 9a and 9b. Note in the example illustrated in FIGS. 8 a-d that the distance between the vertical dashed lines indicates the wavelength shift of the depicted spectral functions compared with FIGS. 6a-d.

To summarize, by separating the axes of polarization of the input light, and tuning the GD of each axis in each of two inverse pairs of resonators using one of the three aforementioned tuning schemes, the AODC invention can compensate both CD and PMD simultaneously or independently.

The following considerations relate to the preferred embodiment and how it functions to compensate CD, or PMD, or CD and PMD simultaneously.

The waveplates (also known as polarization retarders) used in the AODC should be as achromatic as possible in the WL region of interest. They may be zero order or multi-order. In the preferred embodiment shown, the waveplates are quarter wave.

The polarization beamsplitters depicted in the drawings function to direct the different axes of polarization (s and p) in separate directions. They could be composed of: thin film interference coatings in plate or cube form, Brewster plates, birefringent wedges, or birefringent beam displacers, in turn, composed of uniaxial, biaxial, or similar materials.

The polarization controller depicted in the drawings functions to rotate the different axes of polarization (s and p) exiting it to align with the planes of a downstream polarization beamsplitter. The PC could be of any technology type: magneto-optical, ferroelectric, piezo-electric, electro-optic, birefringent uniaxial or biaxial crystals, birefringent liquid crystal cells or retardation plates, or physically rotated crystals. Furthermore, it may be constructed in many ways: micro-optic, free space optics, or planar light circuit, for example. The rotator may or may not function to introduce an additional phase lag between the two axes of polarization.

There exist two broad classes of filters for use in fiber optics: Infinite Impulse Response (IIR) and Finite Impulse Response (FIR). An IIR filter has a feedback mechanism that causes light to travel back and forth within the filter. Examples are all-pass or GT etalon filters, and fiber Bragg gratings. In a FIR filter, light passes through the filter. Examples of a FIR filter are Mach-Zehnder interferometers and Michelson interferometers.

The multi-cavity Gires-Tournois resonators (MCGTR) referred to in the spectral graph of FIG. 4 and the preferred embodiment in FIG. 5 can be of any type of construction among the following: multi-cavity etalons, spatially variable coated GT etalons (previously disclosed), Gires-Tournois Interferometers (GTI), or non-linearly chirped all-pass fiber Bragg gratings. Cascaded or coupled cavity resonators are preferable to single cavity filters to compensate for GD across the broadest transmitted bandwidth, however, both may be used. Resonators may be composed of any material that is transparent in the WL region of interest: dielectric, semiconductor, or metallic; isotropic, birefringent or liquid crystal; solid or air-spaced.

Multiple band shapes can be created using MCGTRs: box shapes, saw tooth positive functions, saw tooth negative functions, and triangular shapes. Through careful selection of combinations of shapes in multiple cavities and multiple resonators both negative and positive GD slopes can be readily created.

With the use of multi-cavity Gires-Tournois resonators, linear effects of the type that result from higher laser energy densities in single mode fiber-based devices are avoided. The light exiting the fiber and propagating through the micro-optic AODC compensator is expanded to maintain low energy density values.

In band ripple effects that have a deleterious effect on receiver BER can also be minimized in the AODC by averaging the ripple values of the multi-cavity etalon designs employed and by using multiply cascaded filters.

The AODC described may be tuned in any of several ways.

Or it may be constructed of resonators that are not tunable, and therefore the AODC imparts a fixed delay in GD. This fixed delay embodiment may be particularly desirable in compensating for a pre-determined magnitude of CD.

In the preferred embodiment, the peak resonance wavelengths of the MCGTRs are changed with respect to the GD. This is accomplished preferentially by changing the optical distance (thickness) between the mirrors, but could also be accomplished by changing the reflectivity of the MCGTRs of the mirrors.

Optical thickness can be changed by thermally changing the refractive index of the resonator materials (glass, silicon, air, or other). Optical thickness can also be changed magneto-optically, electro-optically, piezo-electrically, through angle tuning, or alternative means.

Positive and negative tuning of the GD are both possible; one or more of the resonators can remain fixed while others are tuned; the resonators can be equal or unequal in the magnitude of their dispersion correction, or equal in function, but unequal in magnitude.

The preferred embodiment of the AODC is composed of four multi-cavity GT resonators. This arrangement imparts four degrees of freedom and a folded optical path. Other embodiments that employ 2, 3, 5, . . . n MCGTRs are also possible.

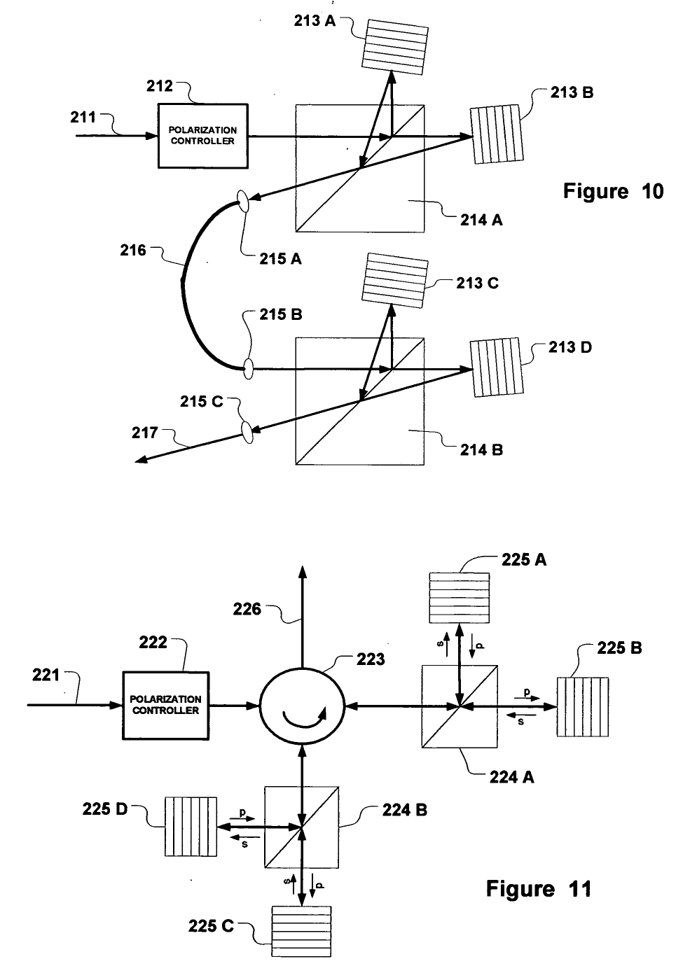

In FIG. 10, an alternative embodiment is illustrated wherein each of four MCGTRs (213a, 213b, 213c, and 213d) are each positioned at a small angle to the face of an exemplified cubic beamsplitter (214a, 214b). The AOI of each axis of polarization reflected or transmitted by the working surface of the beamsplitter as it strikes each MCGTR is slightly greater, or less, than 90 degrees. This embodiment obviates the need for waveplates present in the preferred embodiment of FIG. 5. In practice, the non-normal incidence of each light path as it strikes each MCGTR (213a, 213b, 213c, or 213d) can be minimized, or high index resonator materials used, to reduce undesirable polarization effects. The MCGTRs can also be constructed with a wedged surface to achieve the same result. Because of the non-normal incidence of this embodiment, collimators (215a, 215b, 215c, 215d) are necessary to couple light between adjacent polarization beamsplitters along with a fiber (216)

In FIG. 11, another alternative embodiment employs a multi-port circulator (223) to eliminate the need for waveplates.

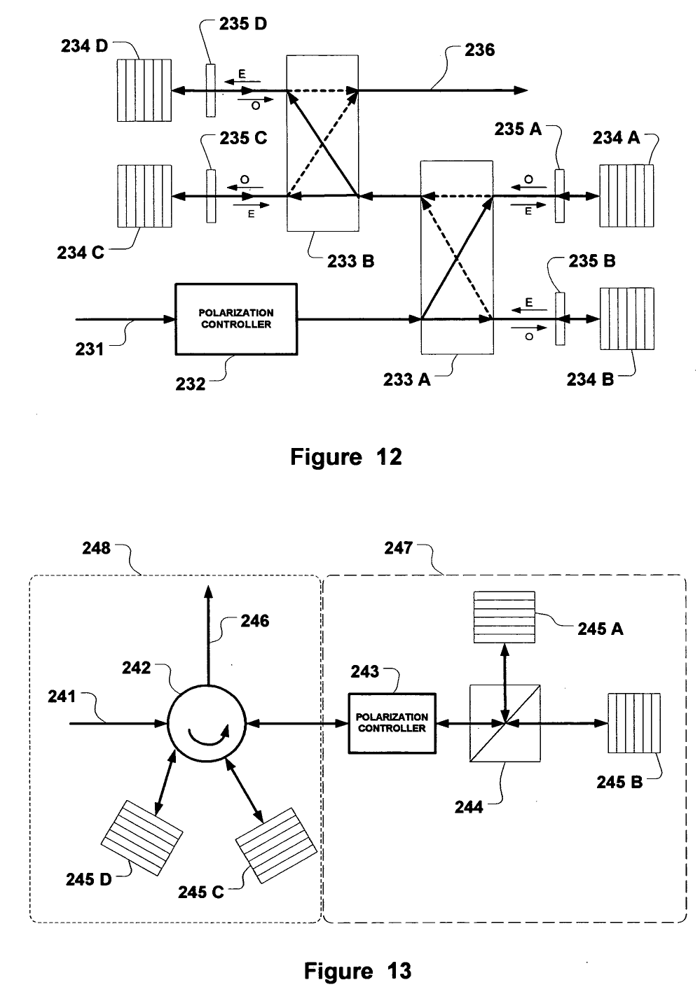

In FIG. 12, another alternative embodiment employs two birefringent beam displacers (233a, 233b) to replace the two polarization beamsplitters (143a, 143b) in the preferred embodiment.

In FIG. 13, the location of the PC (243) in the optical train is changed relative to previous embodiments, and a multi-port circulator (242) added in place of a second polarization beamsplitter. In this alternate embodiment, CD is compensated in the first stage. The CD compensated light then travels through the PC (243) where the DGD is compensated in the second stage (247). In this arrangement, CD and PMD are compensated in series, and not in parallel as in the preferred embodiment illustrated in FIG. 5.

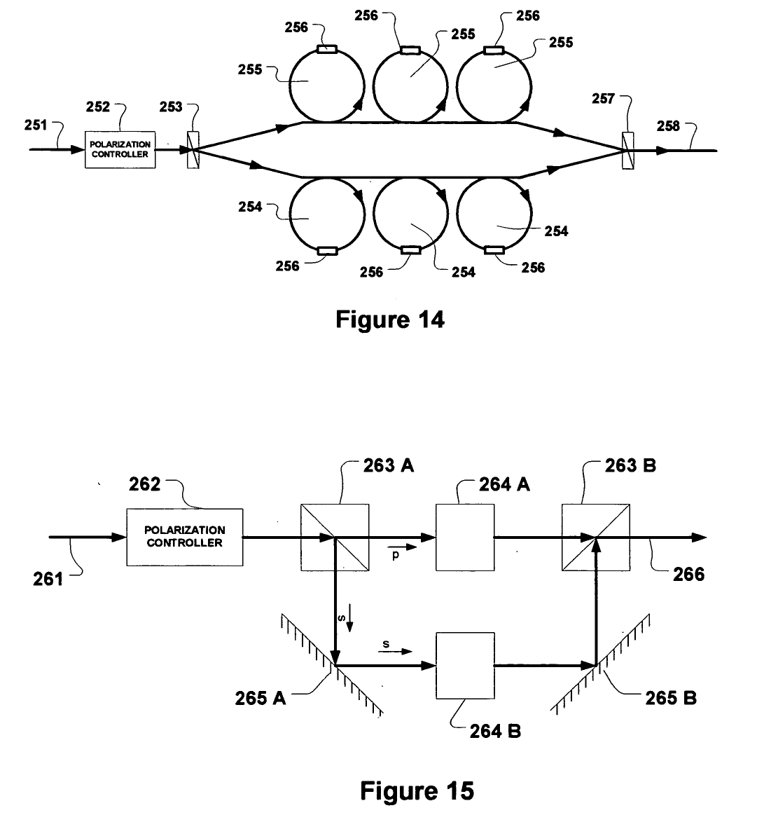

In FIG. 14, an alternate embodiment using cascaded ring resonators (254, 255) is illustrated. In this scheme a polarization beamsplitter (253) directs each axis of polarization into separate arms. The ring resonators depicted in the northern arm (255) are of inverse group delay function to those in the southern arm (254). They may be tuned separately. A polarization combiner (257) recombines the polarized light pulses propagating from the two arms, and the compensated light pulses subsequently exit at output (258).

Although cascaded ring resonators are shown, coupled ring resonators or lattice ring resonators provide equivalent functionality.

In FIG. 15, an embodiment employs two or more FIR filters (264a, 264b) to compensate for CD or PMD independently, or CD and PMD simultaneously. An unbalanced Mach-Zehnder interferometer (MZI) was previously given as an example of a finite impulse filter (FIR). An arrayed waveguide (AWG) is another example of an FIR filter. MZI type FIR filters can compensate for both lower and higher orders of CD. Furthermore, they can be fixed or made tunable through the use of delay lines, thermo optic phase shifters, or tunable couplers. Tuning can be accomplished through thermal, electro-optical, or magneto-optical methods by utilizing a similar feedback loop depicted in FIG. 2 with a tap (not shown in this figure) from the output. Continuous tuning through a range of group delay slopes from positive to negative is possible.

Using coupled or cascaded multi-stage unbalanced Mach-Zehnder interferometers, for example, the magnitude of group delay experienced by a signal pulse can be increased across the transmitted bandwidth. Functional shapes such as saw tooth and rectangular functions can also be created with different MZI filter designs.

In this embodiment a minimum of two FIR filters (264a, 264b) are required. The addition of supplemental FIR filters in this embodiment provides for finer control of higher order dispersion effects and increases the magnitude of dispersion compensation.

In a fashion similar to that of the ring resonator embodiment depicted in FIG. 14, dispersed light pulses passing out of the PC (262) encounter a first polarization beamsplitter (263a) where two parallel arms are created when one axis of polarization (s) is reflected by the first polarization beamsplitter (263a) and the other axis is transmitted. In this embodiment, however, a 45° mirror (265a) redirects the exemplified s axis through the second FIR filter (264b). Another 45° mirror (265b) redirects the compensated s axis light exiting the second FIR (264b) filter back to a second polarization beamsplitter-combiner (263b) where it is recombined with the p axis light compensated by the first FIR filter (264a), and propagates to output (266) or directly to a receiver (not shown).

Additional FIR filters can be located in series between the polarization beamsplitters (263a, 263b) and between the 45° mirrors (265a, 265b), if desired.

To compensate for CD and PMD in this embodiment, each FIR filter is appropriately set to compensate for CD, and furthermore, a relative group delay is set between the two FIR filters to compensate for DGD.

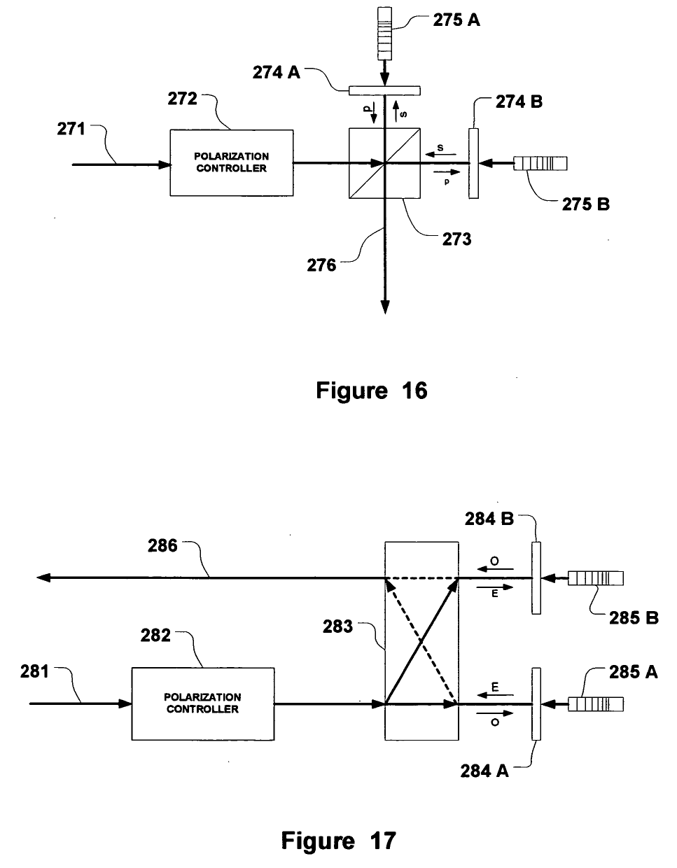

In FIG. 16, a first alternate AODC embodiment employs linearly chirped filters in a basic configuration wherein each of two FBGs (275a, 275b) compensates for group delay in one axis of polarized light with the result that DGD of the input light pulse is compensated.

Unlike conventional FBGs whose period of refractive index modulation is uniform, a chirped FBG has a period of refractive index modulation that varies non-uniformly. Chirped FBGs are subdivided into either linearly chirped or non-linearly chirped. Furthermore, FBGs may be single or multi-channel; sampled or discrete; and can be made to work in either reflection or transmission mode.

Linearly chirped FBGs (single or multi-channel) do not exhibit any change in the slope of their group delay versus wavelength graphs when tuned, however, the group delay slope will shift in wavelength. Tuning can be accomplished: by linear or non-linear mechanical stretching or by non-uniform thermal gradient, and magnetically latched.

By tuning the two linearly chirped FBGs (275a, 275b) in FIG. 16 such that there is relative group delay between them, the DGD of the incoming light pulse can be compensated.

FIG. 17 is a second alternate embodiment of an AODC arrangement using linearly chirped FBGs (285a, 285b) to compensate for DGD wherein a beam displacer (283) is used in place of a polarization beamsplitter.

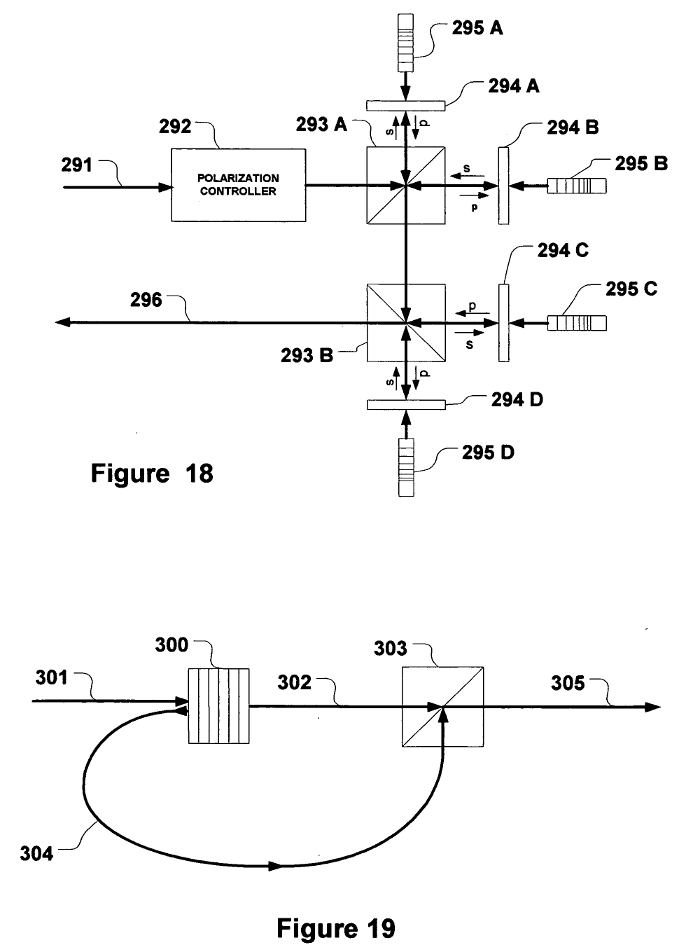

In FIG. 18, another alternate embodiment of the AODC utilizes non-linearly chirped FBGs (295a, 295b, 295c, 295d) to compensate CD and PMD of an input dispersed light pulse.

Unlike linearly chirped FBGs, non-linearly chirped FBGs (NLCFBG) exhibit slope change in their group delay versus wavelength graphs when tuned.

The AODC arrangement in FIG. 18 is substantially the same as that depicted in FIG. 5., and functions in substantially the same way with the exception that the resonators are NLCFBGs.

In FIG. 19 a balanced Fabry-Perot filter (BFP) (300) is shown. Unlike a GT resonator wherein all light passing into the resonator is reflected back out with only a change in phase (an ‘all-pass’ filter), in a BFP the input light is divided into reflected (304) and transmitted (302) outputs. Each of the outputs, however, exhibits identical phase response (group delay and chromatic dispersion response).

In FIG. 19 the BFP (300) has been configured such that the sum of the two outputs is recombined to recover substantially all of the input light. This BFP configuration can also be utilized in an AODC such as the preferred embodiment in FIG. 5.

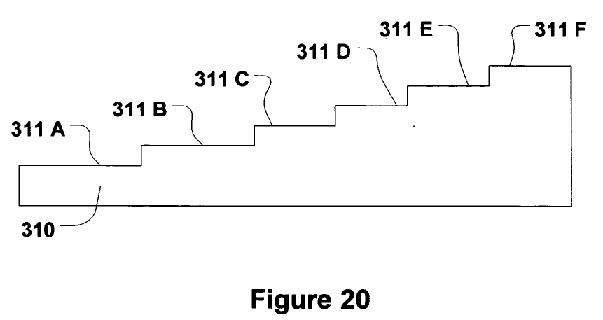

FIG. 20 is one example of a spatially variable filter (SVF) (310) revealed in U.S. patent application Ser. No. 20020191299. The reflected light from differentially spaced single etalons (311a, 311b, 311c, 311d, 311e, 311f) of this sort can be reintegrated to form the desired saw tooth functions for use in any of the AODC arrangements for ‘all-pass’ type filters.

SVFs can be tuned thermally, electro-optically or piezo-electrically, depending on their substrate material.

It can be appreciated by those of ordinary skill in the art that the invention can be embodied in other specific forms without departing from the spirit or essential character hereof. The present invention is therefore considered in all respects to be illustrative and not restrictive. The scope of the invention is indicated by the appended claims, and all changes that come within the meaning and range of equivalents thereof are intended to be embraced therein.

What is claimed is:

1. An optical apparatus for compensating dispersed signal pulses in an optical communication system, said optical apparatus comprising:
an input port for receiving dispersed signal pulses and an output port for exiting of compensated pulses;
a first means for aligning the axes of polarization;
at least one means for directing said axes of polarization to divergent paths that is coupled to said means for aligning the axes of polarization;
a plurality of means for retarding polarization coupled to said means for directing said axes of polarization to divergent paths, in a ratio of two said means for retarding polarization per one said means for directing said axes of polarization to divergent paths;
and a plurality of optical filter means for compensating group delay in an incoming axis of polarized light coupled to said means of retarding polarization, in a ratio of two said optical filter means for compensating group delay in an incoming axis of polarized light per one said means for directing said axes of polarization to divergent paths;

2. The optical apparatus of claim 1 wherein the optical filter means are selected from the group of infinite impulse response filters comprising: all-pass filters, Gires-Tournois interferometers, Gires-Tournois etalons, balanced Fabry-Perot filters, and chirped fiber Bragg gratings.

3. The optical apparatus of claim 1 wherein said optical filter means for compensating group delay in an incoming axis of polarized light are multi-cavity Gires-Tournois resonators.

4. The optical apparatus of claim 1 wherein at least one of said optical filters for compensating group delay displays an inverse group delay versus wavelength function relative to at least one of other said optical filter means for compensating group delay in an incoming axis of polarized light.

5. The optical apparatus of claim 1 wherein polarization mode dispersion of said dispersed signal pulses can be compensated.

6. The optical apparatus of claim 4 wherein chromatic dispersion and polarization mode dispersion of said dispersed signal pulses can be compensated concurrently or independently.

7. The optical apparatus of claim 1 wherein the means for aligning the axes of polarization is dynamic.

8. The optical apparatus of claim 1 wherein said optical filter means for compensating group delay in an incoming axis of polarized light are tunable optical filters.

9. The optical apparatus of claim 8 wherein said tunable optical filters are tuned by a feedback mechanism comprising an optical monitor and a controller.

10. The optical apparatus of claim 8 wherein at least two of said tunable optical filters are tuned in tandem.

11. The optical apparatus of claim 1 wherein two said means for directing said axes of polarization to divergent paths are optically coupled;
and wherein said output port for exiting of compensated pulses is optically coupled to one of said means for directing said axes of polarization to divergent paths.

12. The optical apparatus of claim 1 wherein said means for directing said axes of polarization to divergent paths comprises at least one beam displacer;
and wherein said output port for exiting of compensated pulses is optically coupled to said beam displacer.

13. An optical apparatus for compensating dispersed signal pulses in an optical communication system, said optical apparatus comprising:
an input port for receiving dispersed signal pulses and an output port for exiting of compensated pulses;
a first means for aligning the axes of polarization that is optically coupled to said input port;
and a plurality of optical filter means for compensating group delay in an incoming axis of polarized light coupled to said means for directing said axes of polarization to divergent paths, in a ratio of two said optical filter means for compensating group delay in an incoming axis of polarized light per one said means for directing said axes of polarization to divergent paths;
and wherein said output port for the exit of compensated pulses is coupled to one of said means for directing the said axes of polarization to divergent paths.

14. The optical apparatus of claim 1 wherein said optical apparatus for compensating dispersed signal pulses further includes a circulator disposed between, and optically coupled to said means for aligning the axes of polarization and said means for directing said axes of polarization to divergent paths.

15. The optical apparatus of claim 1 wherein a plurality of optical filter means for compensating group delay in a dispersed signal pulse are coupled to a circulator;
and wherein chromatic dispersion can be compensated by said plurality of optical filter means for compensating group delay in a dispersed signal pulse;
and polarization mode dispersion can be compensated by a plurality of said optical filter means for compensating group delay in an incoming axis of polarized light;
and said circulator is optically coupled to said means for aligning the axes of polarization, and said output port for the exit of compensated pulses.

16. An optical apparatus for compensating dispersed signal pulses comprising:
an input port for receiving dispersed signal pulses and an output port for exiting of compensated pulses;
a first means for aligning the axes of polarization that is optically coupled to said input port;
a means for directing said axes of polarization to divergent paths that is coupled to said means for aligning the axes of polarization;
at least one first optical filter means for compensating group delay in an incoming axis of polarized light that is coupled to the first output of said means for directing said axes of polarization to divergent paths;
at least one second optical filter means for compensating group delay in an incoming axis of polarized light that is coupled to a second output of a means for directing said axes of polarization to divergent paths
and a means for combining compensated signal pulses exiting said first optical filter means for compensating group delay in an incoming axis of polarized light, and second optical filter means for compensating group delay in an incoming axis of polarized light.

17. The optical apparatus of claim 16 wherein the optical filter means for compensating group delay in an incoming axis of polarized light are selected from the group consisting of: cascaded ring resonator filters, coupled ring resonators, and lattice ring resonators.

18. An optical apparatus for compensating dispersed signal pulses comprising:
an input port for receiving dispersed signal pulses and an output port for exiting of compensated pulses;
a first means for aligning the axes of polarization that is optically coupled to said input port;
a means for directing said axes of polarization to divergent paths that is coupled to said means for aligning the axes of polarization;
a first mirror means for redirecting an incoming axis of polarization disposed between said means for directing said axes of polarization to divergent paths and a first optical filter means for compensating group delay in an incoming axis of polarized light;
a second mirror means for redirecting an incoming axis of polarization disposed between said first optical filter means to compensate group delay in an incoming axis of polarized light and a means for combining incoming axes of polarized light;
at least one second optical filter means for compensating group delay in an incoming axis of polarized light that is coupled to said means for directing said axes of polarization to divergent paths and said means for combining incoming axes of polarized light.

19. The optical apparatus of FIG. 18 further including additional optical filter means to compensate group delay in an incoming axis of polarized light coupled to one another and disposed between said first mirror means for redirecting an incoming axis of polarization and said second mirror means for redirecting an incoming axis of polarization

20. The optical apparatus of claim 18 wherein one or more optical filter means to compensate group delay in an incoming axis of polarized light are selected from a group of finite impulse response filters comprising: Mach-Zehnder interferometers, Mach-Zehnder filters, Michelson interferometers, Michelson filters and arrayed waveguides.

21. The method for polarization mode dispersion compensation of a dispersed signal pulse comprising the steps of:
aligning the axes of polarization;
directing each axis of polarized light to a delay element;
changing each linearly oriented axis of polarized light into circularly polarized light axes;
imposing a change in group delay on each axis of said circularly polarized light;
changing the polarization of each axis of said circularly polarized, group delayed light;
and recombining the said two axes of circularly polarized, group delayed light.

22. The method of claim 21 further comprising the steps of:
directing each axis of polarized light to an additional delay element;
changing each linearly oriented axis of polarized light into circularly polarized light axes;
imposing a change in group delay on each axis of said circularly polarized light;
imposing a change in group delay on each axis of said circularly polarized light;
changing the polarization of each axis of circularly polarized, group-delayed light;
and recombining the said two axes of circularly polarized, group-delayed light;

23. The method of claim 22 wherein two of four optical filters for imposing a change in group delay on each axis of polarized light exhibit the inverse group delay function of the two others.

24. The method of claim 22 wherein chromatic dispersion of said dispersed signal pulse is compensated concurrently or independently.
